(19) United States
(12) Patent Application Publication
(10) Pub. No.: US 2026/0253084 A1
(43) Pub. Date: Aug. 27, 2026

(54) AUTOMATED RESOLUTION ENGINE(S) FOR AUTOMATIC GENERATION OF RESOLUTION RECOMMENDATIONS TO INCIDENT QUERIES

(71) Applicant: Oracle International Corporation, Redwood City, CA (US)

(72) Inventors: Mayur Kamalkumar Kanojiya, Ahmedabad (IN); Naveen Thulasidharan, Thiruvananthapuram (IN); Georgy Rajan, Kottayam (IN); Peter Sebastian Kunnel, Thodupuzha (IN); Nithin Nassar, Thiruvananthapuram (IN)

(21) Appl. No.: 19/061,048

(22) Filed: Feb. 24, 2025

(51) Int. Cl. G06Q 30/015

(52) U.S. Cl. CPC G06Q 30/015

(57) ABSTRACT

Various embodiments of the present technology generally relate to systems and methods for providing an automated resolution engine. In an example, the automated resolution engine receives an incident query from a client device and generates an incident fingerprint based on the incident query. Using the incident fingerprint, which may be an embedding representation of the incident query, the automated resolution engine generates artifact fingerprints that are contextually relevant to the incident query. The automated resolution engine then generates one or more resolution step using the artifact fingerprints and the incident fingerprint. In an example, the automated resolution engine submits the artifact fingerprints and incident fingerprints to an artificial intelligence (AI) model that generates the resolution steps responsively. The automated resolution engine may validate the resolution steps against the incident query and generate a resolution recommendation for the incident query responsive to validation of the resolution steps.

### TECHNICAL FIELD

Various embodiments of the present technology generally relate to digital communications and services. More specifically, embodiments of the present technology relate to systems and methods for providing an automated resolution engine for automatic generation of resolution recommendations responsive to incident queries.

### BACKGROUND

In the modern era, service providers increasingly utilize digital platforms to offer customer support, fundamentally changing how users seek assistance. Instead of engaging directly with service team members, customers now submit their queries, incident reports, and service requests through channels like web portals, mobile applications, or email. These systems often employ automated ticketing processes, chatbots, and self-service knowledge bases to streamline support. While these tools provide users with 24/7 accessibility and enable service providers to manage higher volumes of requests efficiently, the responses generated by such systems often remain generic and fail to address the specific nuances of individual queries.

Despite the advancements in digital support systems, conventional approaches to customer service still persist, presenting notable challenges. Under these frameworks, incident queries are typically evaluated and resolved by service team members, requiring users to wait for human intervention. This reliance on manual assessment and personalized attention can result in significant delays, especially during high-demand periods when support resources are stretched thin. As a result, users may experience frustration due to slow resolution times, while the scalability of such systems is inherently limited compared to more automated solutions. However, current automated solutions fail to provide resolution recommendations tailored to the specifics of individual queries.

Accordingly, there exists a need for systems and techniques for an automated resolution engine as provided herein. In particular, there is a need for an automated resolution engine for automatic generation of a resolution recommendation that is tailored to a root cause of an incident query.

The information provided in this section is presented as background information and serves only to assist in any understanding of the present disclosure. No determination has been made and no assertion is made as to whether any of the above might be applicable as prior art with regard to the present disclosure.

### OVERVIEW

Technology is disclosed herein for systems and techniques for providing an automated resolution engine and one or more of its related functions. As described in greater detail below, the automated resolution engine identifies a root cause of an incident query submitted by a user. To identify the root cause, the automated resolution engine generates an incident fingerprint, such as generating an embedding representation of the incident query. Using the incident fingerprint, the automated resolution engine determines whether any past incident threads contain a similar root cause. If so, the automated resolution engine generates a resolution recommendation containing the resolution steps used to resolve the past incident thread and curated knowledge articles or product documentation having the same or similar root cause.

If the automated resolution engine, however, determines that there are no past incident threads containing a similar root cause, the automated resolution engine queries a knowledge base using the incident fingerprint. From the query, the automated resolution engine retrieves knowledge artifacts, which contain historical incident threads and/or knowledge articles, that are contextually relevant to the incident query. Using artifact fingerprints of the knowledge artifacts, the automated resolution engine filters and ranks the knowledge artifacts to identify knowledge artifacts that are most contextually relevant, and therefore most closely related to the root cause of the incident query.

The artifact fingerprints and the incident fingerprint are submitted into an artificial intelligence (AI) model as input. Responsive to receiving the input, the AI model generates an output identifying one or more resolution steps for addressing root cause of the incident query. In some embodiments, the AI model employs a Retrieval-Augmented Generation (RAG) process using the artifact fingerprints to generate the resolution steps for the incident query. Once the output is generated, the automated resolution engine validates the resolution steps against the incident query and generates a resolution recommendation.

Once generated, the resolution recommendation is transmitted to a client device associated with the user. In some embodiments, the user may reply to the resolution recommendation, for example, indicating whether or not the resolution recommendation resolves the root cause of his or her issue. In such cases, the automated resolution engine detects a sentiment in the reply and determines an acceptance ranking for the resolution recommendation based on the sentiment. For instance, if the sentiment in the reply is detected as positive, the automated resolution engine may indicate that the resolution recommendation is accepted and thus ranks the resolution recommendation to indicate this acceptance. In contrast, the sentiment in the reply is detected as negative, the automated resolution engine may indicate that the resolution recommendation is not accepted and rank the resolution recommendation to reflect this lack of acceptance by the user. As will be described in greater detail below, the automated resolution engine leverages the acceptance rating associated with resolution recommendations to determine whether to incorporate the respective incident query thread into the knowledge base or to deprioritize and/or remove respective historical incident threads and/or knowledge articles from the knowledge base.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

The accompanying drawings, which are incorporated into and constitute a part of this specification, illustrate one or more certain aspects and, together with the description of the example, serve to explain the principles and implementations of the certain examples.

FIG. 1 illustrates an example operational environment in which an automated resolution engine is implemented for automatic generation of resolution recommendations responsive to incident queries, according to an embodiment herein;

FIG. 2 illustrates an example operational environment in which an automated resolution engine is implemented to automatically address an incident query, according to an embodiment herein;

FIG. 3 provides an example automated resolution engine process, according to an embodiment herein;

FIG. 4 provides another example automated resolution engine process, according to an embodiment herein;

FIG. 5 illustrates an example incident query, according to an embodiment herein;

FIG. 6 illustrates an example resolution recommendation, according to an embodiment herein;

FIG. 7 illustrates an example incident query thread, according to an embodiment herein;

FIG. 8 illustrates an example knowledge article, according to an embodiment herein; and

FIG. 9 shows an example computing device suitable for providing an automated resolution engine and its related functions, according to an embodiment herein.

Some components or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

Service providers are increasingly relying on digital platforms to deliver customer service and assist customers in resolving issues efficiently. These platforms leverage advanced tools and technologies to streamline the support process and enhance the user experience. For example, many organizations utilize comprehensive customer service suites like Oracle B2C Service, which offer a wide array of features to manage customer interactions effectively. These suites often include tools for handling incident queries, automating ticketing systems, and integrating customer data to provide consistent support across various channels. By adopting such solutions, service providers aim to improve response times, manage larger volumes of queries, and maintain detailed records, ultimately fostering stronger customer relationships and operational efficiency.

Current customer service systems, however, often face limitations in balancing speed and personalization when addressing incident queries. Automated platforms are designed to provide swift responses, but these are frequently generic, lacking the depth or specificity needed to fully resolve a customer's unique issue. While such systems excel in efficiency, their inability to adapt to the nuanced nature of individual queries can lead to frustration for users seeking tailored support. On the other hand, systems that rely on service agents to deliver personalized responses ensure a more thorough understanding of the customer's concerns but are inherently slower. The reliance on human intervention often results in delayed resolutions, particularly during periods of high demand, as queries must be queued, evaluated, and addressed by a limited number of agents. This trade-off between speed and specificity remains a significant challenge in current customer service models.

These shortcomings of conventional customer service systems can lead to several negative consequences for both users and service providers. When users encounter delayed responses due to the reliance on service agents, frustration often builds, particularly if their issues are time-sensitive or critical. This delay can erode trust in the service provider and reduce overall customer satisfaction. Additionally, when automated systems deliver generic responses that fail to address the specific details of a query, users may feel unheard or undervalued, further compounding dissatisfaction. These shortcomings can result in unresolved issues, forcing users to repeatedly contact support, which not only increases their frustration but also places additional strain on service teams. Over time, such inefficiencies can harm a company's reputation, drive customer churn, and reduce overall operational effectiveness, highlighting the pressing need for more balanced and effective support solutions.

To address at least these shortcomings of conventional customer service systems, an example automated resolution engine is provided herein. As will be described in greater detail below, the automated resolution engine provided herein identifies a root cause of an incident query submitted by a user and generates a resolution recommendation based on this root cause. The resolution recommendation is generated based on historical incident threads and/or knowledge articles that are contextually relevant to the root cause, thereby providing tailored resolution steps to the specific problem identified in the incident query.

The automated resolution engine continuously evaluates incident query threads, which include all interactions with the user for a respective issue (e.g., incident query, resolution recommendation, reply), and updates its knowledge base based on whether the issue is resolved by the provided resolution recommendation. Moreover, for resolution recommendations that are accepted by users (e.g., indicated as resolving the issue of the incident query), the automated resolution engine may publish a knowledge article providing the resolution steps for addressing the issue so that other customers can address the same issue without needing to submit an incident query.

By leveraging historical incident threads and knowledge articles that are contextually relevant to an incoming incident query, the automated resolution engine provides a resolution recommendation tailored to the specific root cause of the incident query. Moreover, because the automated resolution engine generates the resolution recommendation automatically, without need for input from a service agent, resolution recommendations are generated and provided to users swiftly, ensuring timely resolution. As can be appreciated, this automatic and timely resolution of incident queries allows the automated resolution engine to manage high-traffic incidents, even during peak hours, without undue stress or burden on users and service agents.

By streamlining the resolution process, an automated resolution engine optimizes the use of service agents’ and subject matter experts’ time and resources. Routine queries are efficiently managed by the automated resolution engine, allowing service agents to focus on addressing more complex issues, thereby enhancing resource allocation. Beyond resolving queries, the automated resolution engine also enables service providers to quickly identify significant product defects, paving the way for proactive actions such as product recalls or instructional fixes. Overall, the automated resolution engine offers a comprehensive solution that not only ensures the swift and effective resolution of customer concerns but also drives continuous improvement and adaptability, addressing emerging challenges in the customer service landscape.

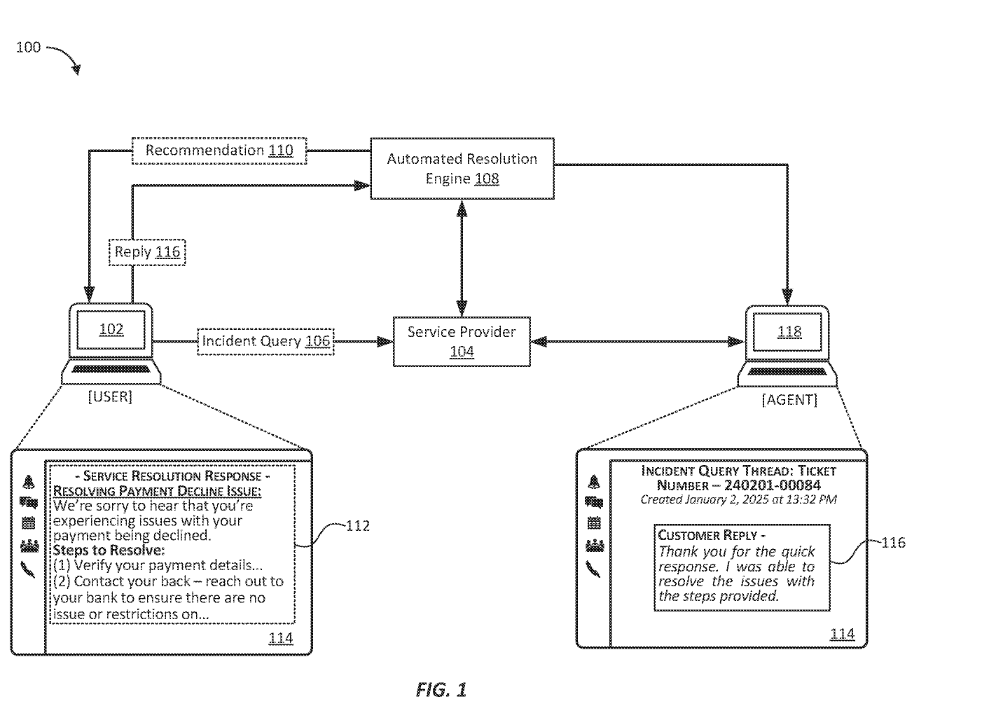

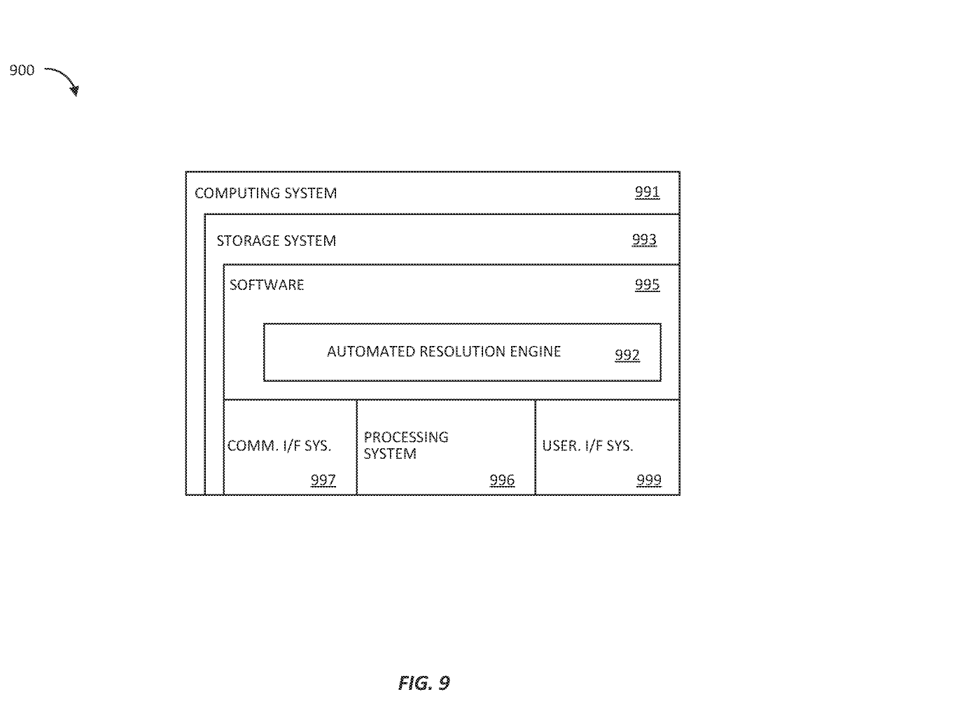

Turning now to the Figures, FIG. 1 illustrates an example operational environment 100 in which an automated resolution engine 108 is implemented for automatic generation of resolution recommendations responsive to incident queries, according to an embodiment herein. As illustrated, a client device 102, typically associated with a user or customer, is in operable communication with a service provider 104. Examples of the client device 102 may include personal computers, tablet computers, mobile phones, gaming consoles, wearable devices, Internet of Things (IoT) devices, and any other suitable devices, of which computing apparatus 991 in FIG. 9 is also broadly representative.

The client device 102 is in operable communication with the service provider 104 to receive various services. To facilitate this communication, the client device 102 may use a range of networks, such as a 4G or 5G communications network. Additionally, the connection could occur through a local area network (LAN), a wide area network (WAN), a wireless network (e.g., Wi-Fi), a satellite network, or a hybrid network that integrates multiple technologies.

At some point, the user of the client device 102 may encounter an issue with the services provided by the service provider 104. This could involve difficulties accessing features, experiencing service interruptions, or encountering other technical problems. In response to the issue, the client device 102 submits an incident query 106 to the service provider 104, requesting assistance to address the problem. As will be described in greater detail below, the incident query 106 typically contains details about the issue, allowing the service provider 104 to evaluate and resolve the matter efficiently. This submission initiates a support process aimed at troubleshooting and providing a resolution to the user’s concerns. In particular, the submission of the incident query 106 initiates the automated resolution engine process described herein.

As illustrated, the automated resolution engine 108 is in operable communication with the service provider 104 and the client device 102. As such, in some embodiments, responsive to receiving the incident query 106, the service provider 104 passes the incident query 106 to the automated resolution engine 108. In other embodiments, however, the client device 102 may transmit the incident query 106 directly to the automated resolution engine 108. As shown, the automated resolution engine 108 may be remotely located from the client device 102 and is in operable communication with the client device 102 to provide one or more of the functions described herein.

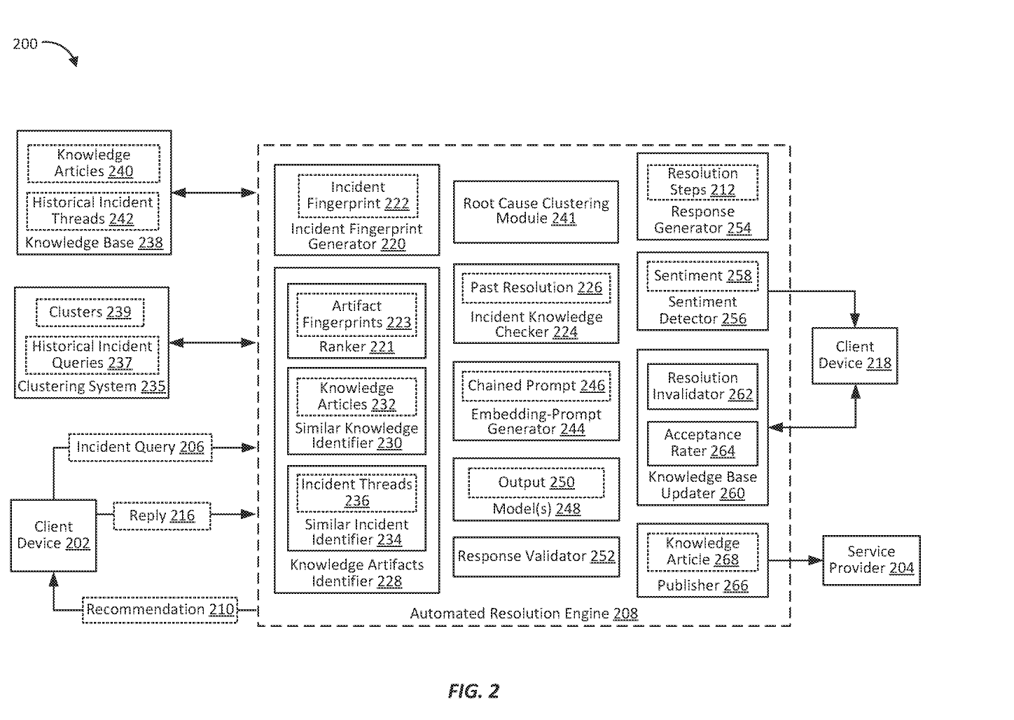

Responsive to receiving the incident query 106, either directly or via the service provider 104, the automated resolution engine 108 determines a root cause of the incident query 106 and generates a resolution recommendation 110 to address the root cause. Identification of the root cause and generation of the resolution recommendation 110 are described in greater detail with respect to FIGS. 2-8. Once generated, the automated resolution engine 108 sends the resolution recommendation 110 to the client device 102. As depicted, the user of the client device 102 can review and interact with the resolution recommendation 110 through a user interface 114 provided by the client device 102. This interface 114 allows the user to engage with the resolution recommendation 110, enabling them to take the appropriate steps to address the issue.

As shown, the resolution recommendation 110 includes one or more resolution steps 112 for addressing the issue provided in the incident query 106. As will be described in greater detail below, the resolution steps 112 are generated based on the root cause identified in the incident query 106. In an example, the resolution steps 112 are generated using knowledge artifacts, which include historical incident threads and knowledge articles, that are contextually relevant to the incident query 106. In some cases, the resolution steps 112 incorporate or include resolution steps that were previously provided for addressing a past incident query that involved the same or similar root cause.

By generating resolution steps based on knowledge artifacts and/or past incident threads having similar or the same root cause, the automated resolution engine 108 generates and provides the resolution recommendation 110 in a timely manner to the client device 102. For instance, the automated resolution engine 108 may generate and provide the resolution recommendation 110 within minutes of receiving the incident query 106. As can be appreciated, this swift response may foster a positive experience for the user of the client device 102, providing them with resolution steps 112 within minutes of submitting the incident query 106. Moreover, if multiple incident queries 106 are received, all having the same root cause, the automated resolution engine 108 can flag the root cause for immediate attention by the service provider 104, thereby allowing for swift mitigation of issues from a more comprehensive angle.

Responsive to reviewing the resolution steps 112, the user of the client device 102 may respond to the resolution recommendation 110 with a reply 116. The reply 116 may provide the user’s response to the resolution recommendation 110, such as by indicating that the resolution steps 112 resolved the issue or that the resolution steps 112 failed to resolve the issue. As such, the automated resolution engine 108 evaluates the reply 116 to detect any sentiment present in the reply 116. As will be described in greater detail below, if the automated resolution engine 108 detects positive sentiment in the reply 116, the automated resolution engine 108 may rate the resolution steps 112 associated with the incident query 106 to indicate that it is accepted by the user. Similarly, if the automated resolution engine 108 detects a negative sentiment, the automated resolution engine 108 rates the resolution recommendation 110 to indicate that the resolution steps 112 are invalid for addressing the incident query 106, and thus not accepted by the user. The rating of a respective resolution recommendation is used by the automated resolution engine 108 to identify resolution steps moving forward for similar incident queries.

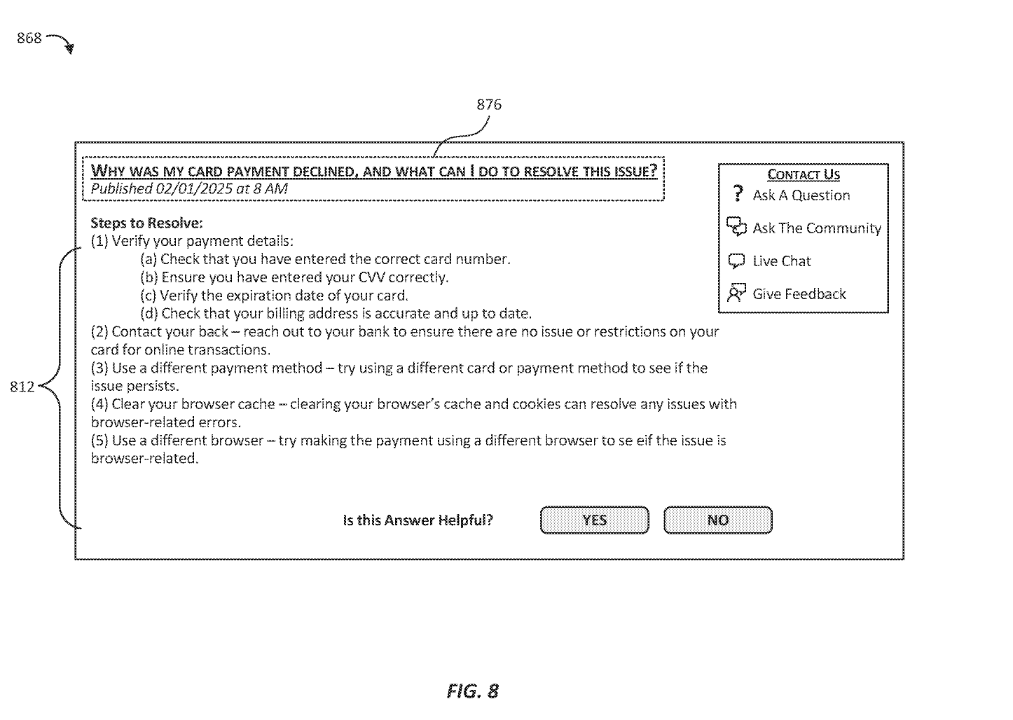

In some embodiments, the automated resolution engine 108 is in operable communication with an agent client device 118. That is, the client device 118 corresponds to a service agent associated with the service provider 104. When the automated resolution engine 108 identifies an incident query thread having a high acceptance rate by a user, the automated resolution engine 108 may recommend that the resolution steps 112 be published via a public-facing application. In the illustrated example, the automated resolution engine 108 provides the reply 116 to the client device 118, where the service agent reviews the reply 116 via the user interface 114 to appreciate the incident query thread. If, after reviewing the thread, the service agent determines that publishing the resolution steps 112 would be beneficial, the client device 118 can instruct the automated resolution engine 108 to create a knowledge article containing the resolution steps 112 and publish it on a public-facing platform, such as a Frequently-Asked-Questions (FAQ) page associated with the service provider 104. An example knowledge article is illustrated and described below with respect to FIG. 8. Publishing the resolution steps 112 on a public-facing application helps improve customer self-service, reducing the volume of similar queries and enhancing overall user satisfaction by providing readily accessible solutions.

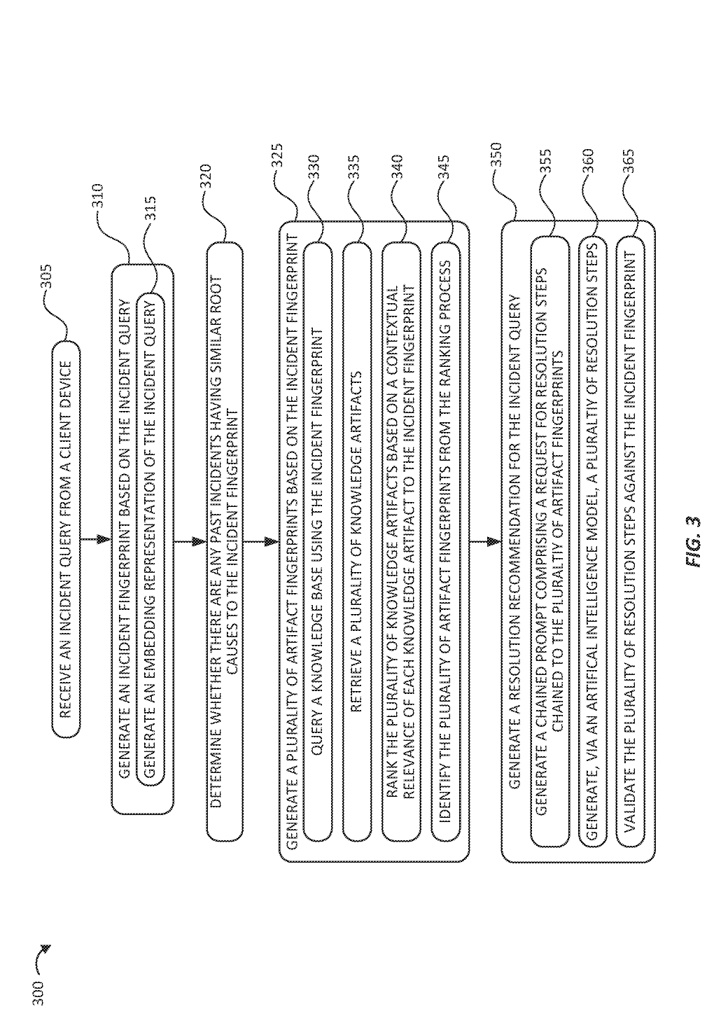

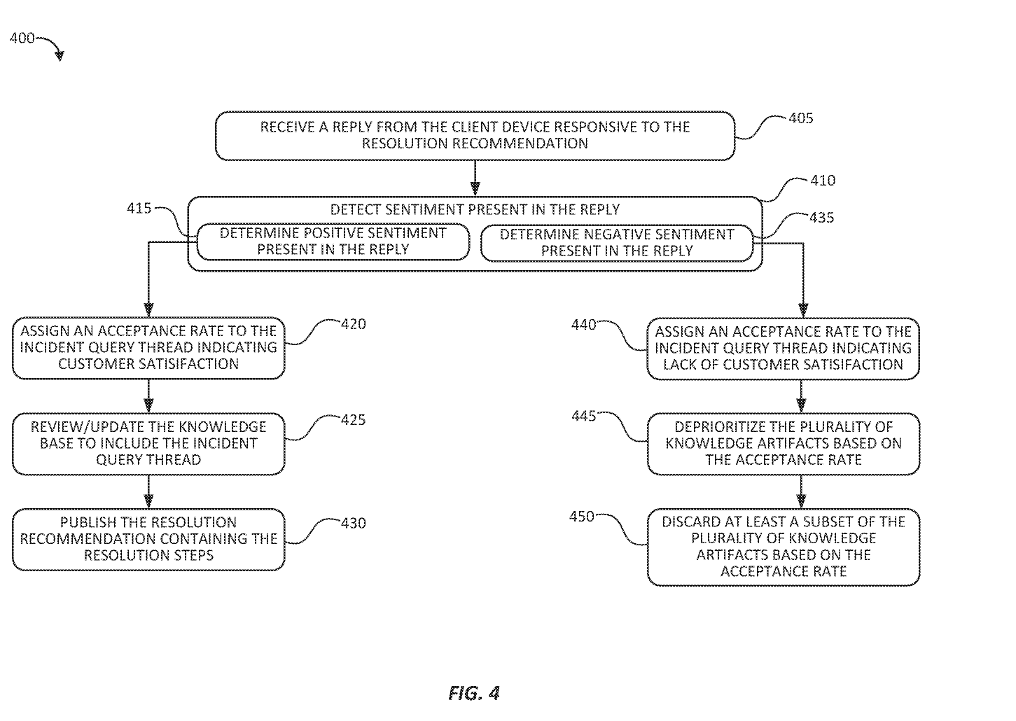

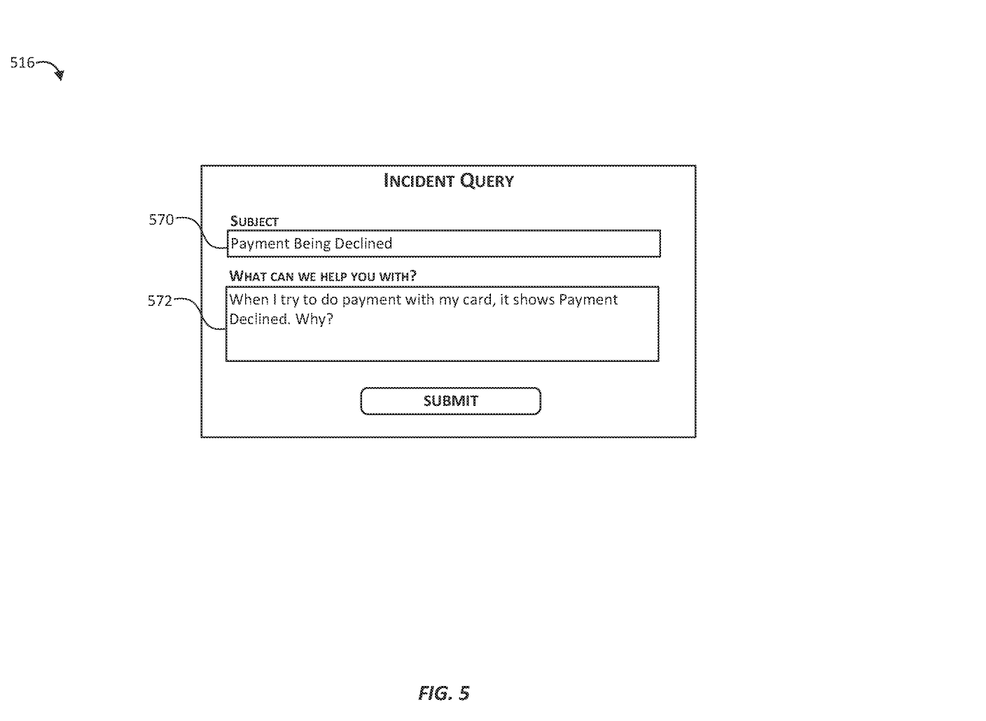

Referring now to FIG. 2, an example operational environment 200 in which an automated resolution engine 208 is implemented to automatically address an incident query submitted by a client device 202 is provided, according to an embodiment herein. For ease of explanation, FIG. 2 is described in conjunction with FIG. 3 and FIG. 4, which provide example automated resolution engine processes, in particular processes 300 and 400 for providing the automated resolution engine 208 and one or more of its functions, respectively, according to an embodiment herein. While FIGS. 3 and 4 are described with relation to FIG. 2, it should be appreciated that components, elements, and steps from any other Figures described herein may be equally applicable. FIG. 2 is initially described with respect to FIG. 3 and then subsequently with respect to FIG. 4. FIG. 2 is also described with respect to FIGS. 5-8, each of which is referenced in turn in the following description.

As illustrated, the client device 202 is in operable communication with the automated resolution engine 208, which may be the same or similar to the client device 102 and the automated resolution engine 108, respectively. In some cases, the client device 202 may directly interact with the automated resolution engine 208, while in other embodiments the client device 202 may communicate with the automated resolution engine 208 via a service provider 204, which may be the same or similar to the service provider 104. As noted above, the automated resolution engine 208 may be executed remotely, such as on a server or cloud infrastructure, while maintaining communication with the client device 202 to perform one or more of the functions described herein. Alternatively, in some embodiments, the automated resolution engine 208 may be installed and executed locally on the client device 202, allowing for direct interaction with the client device 202.

As shown, to initiate the automated resolution engine processes provided herein, an incident query 206 is received by the automated resolution engine 208 (305). As described above, in some cases, the client device 202 submits the incident query 206 directly to the automated resolution engine 208, while in other scenarios the client device 202 submits the incident query 206 to the service provider 204 which routes the incident query 206 to the automated resolution engine 208. The incident query 206 may be submitted responsive to a user of the client device 202 experiencing an issue with a service provided by the service provider 204. As such, the client device 202 submits the incident query 206 to request assistance to address and resolve the issue.

Referring now to FIG. 5, an example incident query 506 is provided, according to an embodiment herein. As shown, the incident query 506 includes a subject line 570 and a body 572 describing the issue the user of the client device 202 is experiencing. In the illustrated example, the incident query 506 involves “Payment Being Declined” and includes a description of how when the user tries to use his or her card, the payment is declined. As can be appreciated, the incident query 506 may take various forms, depending on the platform and communication style used for submission. For example, the incident query 506 may be an online submission form, an email, a text message, a voice-to-text transcription of a phone call, or even a social media post.

Returning to FIG. 2, responsive to receiving the incident query 206, the automated resolution engine 208 generates an incident fingerprint 222 from the incident query 206 (310). In particular, the automated resolution engine 208 includes an incident fingerprint generator 220 that generates the incident fingerprint 222. In some embodiments, to generate the incident fingerprint 222, the incident fingerprint generator 220 generates an embedding representation of the incident query 206 (315). In such cases the incident fingerprint generator 220 may be an embedding generator that processes the incident query 206 to generate the embedding representation.

In some embodiments, to generate the incident fingerprint 222, the incident query 206 is preprocessed using one or more Natural Language Processing techniques, such as removing any HTML tags, personal identification information (PII), and/or special characters from the incident query 206. After preprocessing, the cleaned query information is submitted to the incident fingerprint generator 220, which may include a generative AI embedding model that converts the process query information into an embedding. As those skilled in the art readily appreciate, an embedding is a numerical representation of the input data, here the processed incident query 206, typically in the form of a high-dimensional vector, that captures the semantic meaning and relationships within the text. That is, the incident fingerprint generator 220 transforms the processed incident query 206 into a dense vector, where words or phrases with similar meanings are closer together in the vector space. This dense vector, also referred to herein as an embedding, is used to form the incident fingerprint 206. Because the incident fingerprint 206 is a quantification of the incident query 206, it reflects the root cause of the issue identified in the incident query 206.

To identify the root cause of the incident query 206, the automated resolution engine 208 interfaces with a clustering system 235. The clustering system 235 clusters historical incident queries 237 into a plurality of clusters 239 based on root cause. That is, the clustering system 235 may be trained on historical incident query data spanning over a predefined time period (e.g., 3 months, 6 months) to identify patterns and similarities within the historical incident queries 237. By analyzing patterns and similarities within the historical incident queries 237, often within a defined time period, the clustering system 235 can identify and group related incident queries into distinct clusters 239. This data-driven approach enables detection of underlying trends, correlations, and recurring issues, facilitating a structured and efficient categorization of historical incident queries 237.

The clustering system 235 analyzes the incident fingerprint 222 against these clusters 239 to identify a matching cluster containing contextually relevant historical incident queries 237. Upon identification of the matching cluster, the automated resolution engine 208 extracts associated agent responses for each historical incident query within the cluster 239. The automated resolution engine 208 then employs a root cause clustering module 241 to group similar agent responses. Based on the frequency of occurrence within the cluster 239, the root cause clustering module 241 generates a first set of top N probable causes. Additionally, the automated resolution engine 208 identifies the top five historical incident queries 237 that exhibit the highest similarity scores when compared against the current incident query 206, along with their corresponding root causes, thereby generating a second set of probable causes. The automated resolution engine 208 then applies a weighted averaging algorithm to combine the first and second sets of probable root causes, ultimately producing a ranked list of the most probable root causes for the given incident query 206. The automated resolution engine 208 may then determine the root case for the incident query 206 from the ranked list of most probable root causes.

In some embodiments, the incident fingerprint 222 includes additional information beyond the embedding. For example, the incident fingerprint 222 may include various metadata associated with the incident query 206, such as information relating to the client device 202 or respective user, such as the device type (e.g., smartphone, tablet, or desktop), operating system, geographic location (e.g., based on IP address or GPS data), or user preferences and settings (e.g., language preferences or accessibility settings). Additionally, the incident fingerprint 222 may encapsulate contextual information about the query itself, such as timestamps, session identifiers, or the sequence of prior interactions leading up to the incident query 206.

Once the incident fingerprint 222 is generated, the automated resolution engine 208 determines whether there are any past incidents having similar root causes to the incident fingerprint 222 (320). In particular, the automated resolution engine 208 includes an incident knowledge checker 224 that determines whether there are any past resolutions 226 that match the root cause identified by the incident fingerprint 222. In some embodiments, the incident knowledge checker 224 may compare the incident fingerprint 222 to the fingerprints generated for past incidents threads and if the incident fingerprints 222 match or are substantially similar within a predefined standard deviation to the past fingerprints, the automated resolution engine 208 identifies the past resolutions 226 for addressing the incident query 206.

In an embodiment, the incident knowledge checker 224 includes a cache (not shown) of recent incident query threads resolved by the automated resolution engine 208. For example, if the automated resolution engine 208 generates and sends a resolution recommendation to a client device, which in turn indicates that this resolution recommendation solves the problem identified in the respective incident query, the automated resolution engine 208 may cache this incident query thread in the incident knowledge checker 224. As used herein, an incident query thread includes the interactions between the client device 202 and the automated resolution engine 208 involved in responding to an incident query. In the illustrated example, the incident query thread includes the incident query 206, the resolution recommendation 210, and the reply 216. As will be described in greater detail below, the automated resolution engine 208 may cache only incident query threads in which a reply 216 indicates resolution of the problem.

By caching the incident query threads of resolved issues, the automated resolution engine 208 can efficiently identify past resolutions 226 for subsequent incident queries having the same or similar root causes. For example, if a problem arises in which multiple users experience the same issue, instead of having to perform the subsequent steps for each incident query, the automated resolution engine 208 can identify resolution steps that rectify the issue and reference it for each subsequent incident query.

In contrast, if the automated resolution engine 208 determines that there are no past resolutions 226 that address the root cause identified in the incident fingerprint 222, the automated resolution engine 208 identifies knowledge artifacts that are contextually relevant to the incident fingerprint 222 to generate a resolution recommendation to the incident query 206. To identify knowledge artifacts that are contextually relevant to the incident query 206, in some embodiments, the automated resolution engine 208 generates artifact fingerprints 223 based on the incident fingerprint 222 (320). In particular, the automated resolution engine 208 includes a knowledge artifact identifier 228 that generates or identifies artifact fingerprints 223 that are contextually relevant to the incident fingerprint 222.

In some embodiments, to generate the artifact fingerprints 223, the knowledge artifacts identifier 228 queries a knowledge base 238 using the incident fingerprint (330). As shown, the knowledge base 238 includes knowledge articles 240 and historical incident threads 242. The knowledge articles 240 include documentation on various services, issues, and resolution steps prepared by the service provider 204. Examples include service manuals, FAQs, troubleshooting guides, technical specifications, user guides, best practice recommendations, and configuration instructions. The historical incident threads 242 include past incident query threads that have been resolved. As noted above, an incident query thread encompasses the exchanges between a client device and the service provider 204 and/or the automated resolution engine 208 for a respective incident. Resolved incident threads are those that users indicated as resolving a respective issue. In some cases, resolution is determined based on a reply from the user responsive to a resolution recommendation, as described below. In other scenarios, resolution is determined by a lack of a reply from a user.

In some embodiments, the knowledge artifact identifier 228 includes a similar knowledge identifier 230 that queries the knowledge base 238 for knowledge articles 232 that are similarly relevant to the incident query 206. To retrieve the knowledge articles 232, the similar knowledge identifier 230 queries the knowledge base 238 with the incident fingerprint 222. Since the incident fingerprint 222 encapsulates the root cause (e.g., semantic essence) of the incident query 206, the knowledge base 238 matches the incident fingerprint 222 against is repository of knowledge articles 240, which may also be represented in a similar vectorized format, to identify the knowledge articles 232.

The knowledge artifact identifier 228 includes a similar incident identifier 234 that identifies incident threads 236 that are similarly relevant to the incident query 206. Similar to the above, the similar incident identifier 234 submits the incident fingerprint 222 to the knowledge base 238 which compares the incident fingerprint 222 against the historical incident threads 242. The historical incident threads 242, which may also be in the vectorized format of an embedding, capture the context and root cause of past user incident exchanges. As such, when the knowledge base 238 compares the incident fingerprint 222 against the historical incident threads 242, the similar incident identifier 234 identifies the incident threads 236 that are most contextually relevant to the incident query 206.

In some embodiments, the historical incident threads 242 may be clustered within the knowledge base 238 by cluster topic. That is, historical incident threads 242 relating to the same root cause may be clustered together under the same cluster topic (e.g., shipping issue; product recall). In such cases, the similar incident identifier 234 may query the knowledge base 238 for historical incident threads 242 that relate to the same root cause as the incident query 206.

As noted above, responsive to the query, the automated resolution engine 208 retrieves a grouping of knowledge artifacts from the knowledge base 238 (335). The knowledge artifacts include the knowledge artifacts 232 and incident threads 236 identified as contextually relevant to the incident fingerprint 222. Once retrieved, the knowledge artifact identifier 228 ranks the knowledge artifacts based on the contextual relevance of each knowledge artifact to the incident fingerprint 222 (340). For instance, the knowledge artifacts identifier 228 may include a ranker 221 that ranks the knowledge artifacts to identify a subset of knowledge artifacts that are most contextually relevant to the incident query 206.

In some embodiments, the ranker 221 performs the ranking process on the knowledge articles 232 to identify the knowledge articles 232 that are most contextually relevant and then again on the incident threads 236 to identify the incident threads 236 that are most contextually relevant. In some embodiments, the ranking process involves one or more ranking steps. An initial ranking step may include weighing the knowledge articles based on degree of positive resolution of a respective issue. For instance, the ranker 221 may identify knowledge articles that include a positive resolution from the user, such as incident threads 236 including a reply 216 from the user containing positive sentiment, thereby indicating positive resolution of that respective issue. Incident threads 236, and knowledge articles 232 associated with those threads (e.g., directed to the same root cause), may be ranked as having the highest priority or greatest weight. Next, the ranker 221 identifies knowledge articles in which resolution of a respective incident is assumed based on a lack of reply 216 from the user. From this initial ranking process, the ranker 221 generates a grouping of ranked knowledge artifacts.

After the initial ranking step, the ranker 221 may apply a Cohere reranking process to the ranked knowledge artifacts to refine their ordering based on contextual relevance to the incident query 206. The Cohere reranking process utilizes a cosine similarity-based methodology to evaluate the relationship between the ranked knowledge artifacts and the incident fingerprints 222. As described above, each knowledge artifact is represented as a vector, referred to as an artifact fingerprint 223, which is compared against the incident fingerprint 222. The reranking process computes the cosine similarity between each artifact fingerprint 223 and the incident fingerprint 222, where cosine similarity measures the angular distance between the vectors in the embedding space. A higher cosine similarity score indicates greater contextual relevance to the incident query 206. Based on these similarity scores, the Cohere reranking process adjusts the order of the knowledge artifacts, prioritizing those that are most aligned with the incident fingerprint 222. This ensures the final ranked list emphasizes knowledge artifacts that are more contextually pertinent to the incident query 206.

From the reranking process, the ranker 221 generates or identifies the artifact fingerprints 223 that contain the most contextually relevant content to the incident query 206 (345). For example, the ranker 221 may select the top three knowledge articles 232 and the top three incident threads 236 based on the reranking process for the artifact fingerprints 223. In other embodiments, the ranker 221 may select the top 5 or 6 knowledge artifacts for the artifact fingerprints 223 regardless of whether they are knowledge articles 232 or incident threads 236. It may be advantageous to include at least one knowledge artifact from each category (knowledge articles 232 and incident threads 236) to increase the scope of referenced material in the resolution generation step.

Once the artifact fingerprints 223 are identified, the automated resolution engine 208 generates a resolution recommendation 210 for the incident query 206 (350). To generate the resolution recommendation 210, the automated resolution engine 208 includes an embedding-prompt generator 244 that generates a chained prompt 246 (355). The chained prompt 246 is a structured input that links the incident fingerprint 222 with the additional contextual data, here the artifact fingerprints 223, to enhance the precision and relevance of a generated response, here the resolution recommendation 210. As such, the embedding-prompt generator 244 generates the chained prompt 246 to include a request for resolution steps for the incident fingerprint 222 that is chained to the artifact fingerprints 223. In other words, the embedding-prompt generator 244 generates a prompt that links the incident fingerprint 222 to the artifact fingerprints 223.

The automated resolution engine 208 processes the chained prompt 246 and submits it as an input to an AI model 248 (360). The AI model 248 may be a Retrieval-Augmented Generation (RAG) model, which is designed to retrieve relevant information using the artifact fingerprints 223. These artifact fingerprints 223 serve as unique identifiers or metadata associated with specific data sources within the knowledge base 238. Leveraging the artifact fingerprints 223, the RAG model 248 retrieves contextually relevant information from the knowledge base 238 and generates an output 250 that is informed by the retrieved data. As such, the model 248 generates the output 250 containing one or more resolution steps 212 for addressing the incident query 206.

In some embodiments, the automated resolution engine 208 is equipped with a response validator 252, which is responsible for validating the resolution steps 212 identified in the output 250 (265). The validation process involves comparing the resolution steps 212 with the incident query 206. The response validator 252 performs this comparison by analyzing key attributes, such as the context, keywords, and critical elements in both the resolution steps 212 and the incident query 206. By validating the output 250, the response validator 252 ensures that the resolution steps 212 are accurately aligned with the specifics of the incident query 206, ensuring relevance and correctness in the resolution process.

Once the resolution steps 212 are validated, a response generator 254 generates the resolution recommendation 210 containing the resolution steps 212. The resolution recommendation 210 is then transmitted to the client device 202. As described above, responsive to receiving the resolution recommendation 210, a respective user may view and interact with the resolution recommendation 210 via a user interface, such as the user interface 114.

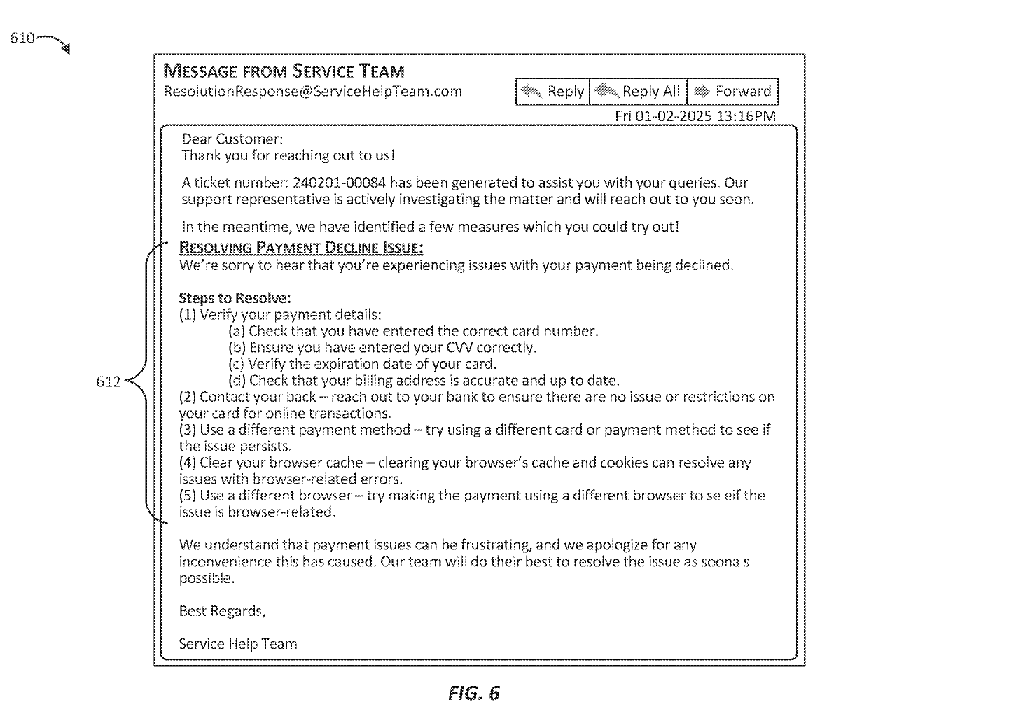

Referring now to FIG. 6, an example resolution recommendation 610 is illustrated, according to an embodiment herein. The illustrated example resolution recommendation 610, is provided in an email format, however, it should be appreciated that the resolution recommendation 610 may be provided in any other format. In some embodiments, the resolution recommendation 610 may reflect the format of the incident query 206. For example, if the incident query 206 is submitted via a text message, then the resolution recommendation 610 may be in text message format as well. In the illustrated embodiment, the resolution recommendation 610 includes the resolution steps 612 generated by the automated resolution engine 208 responsive to the incident query 506, described above. As such, the resolution steps 612 may be from the output 250 generated by the model 248 based on the incident fingerprint associated with the incident query 506.

Returning now to FIG. 2, responsive to receiving the resolution recommendation 210, which may be the same or similar to the resolution recommendation 610, a user of the client device 202 may respond to the resolution recommendation 210. For example, the client device 202 may provide a reply 216 to the automated resolution engine 208 responsive to the resolution recommendation 210. As such, the automated resolution engine 208 receives the reply 216 from the client device 202 responsive to the resolution recommendation 210 (405). In some embodiments, the automated resolution engine 208 evaluates the reply 216 to detect sentiment present in the reply 216 (410).

To detect sentiment 258 present in the reply 216, the automated resolution engine 208 may include a sentiment detector 256. The sentiment detector 256 may be a natural language processing (NLP) module or algorithm that analyzes the textual content of the reply 216 to identify the sentiment 258. As such, the sentiment detector 256 may parse the reply 216 to assess the emotional tone, such as positive, negative, or neutral, based on predefined linguistic patterns, sentiment lexicons, or machine learning models. Based on the sentiment 258, the automated resolution engine 208 may determine whether the resolution recommendation 210 was accepted by the user, and thus resolved the issue, or was rejected by the user, and thus failed to resolve the issue. Each of these scenarios are discussed in turn below.

In some embodiments, the sentiment detector 256 determines a positive sentiment present in the reply 216 (415). As noted above, a positive sentiment is interpreted by the automated resolution engine 208 as an acceptance of the resolution recommendation 210 by the user and assumed to resolve the underlying issue. As such, the automated resolution engine 208 assigns an acceptance rate to the incident query thread indicating customer satisfaction (420). In particular, the automated resolution engine 208 includes a knowledge base updater 260 that includes a resolution invalidator 262 and an acceptance rater 264. The acceptance rater 264 receives the sentiment 258 from the sentiment detector 256 and assigns an acceptance rate to the incident query thread, which in the illustrated example includes the incident query 206, the resolution recommendation 210, and the reply 216. As can be appreciated, the acceptance rate may take various forms, such as a numerical value assignment or a percentage representation, a categorical label indicating levels of acceptance (e.g., high, medium, low), or a binary indicator signifying acceptance or rejection.

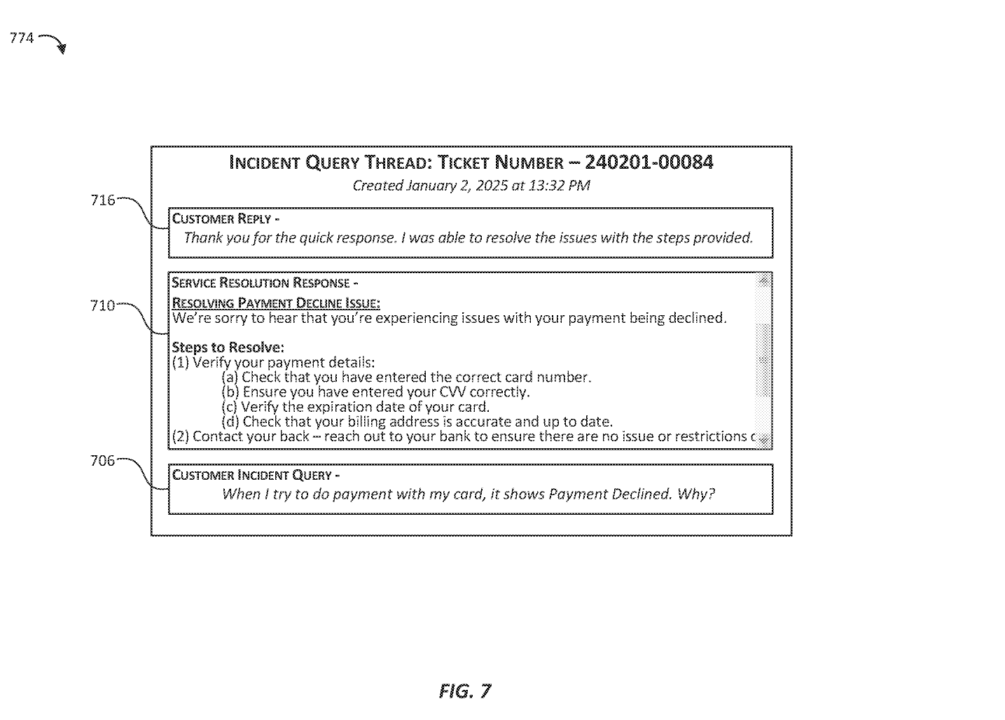

Referring briefly to FIG. 7, an example incident query thread 774 is provided, according to an embodiment herein. As illustrated, the incident query thread 774 includes an incident query 706, which may be the same or similar to the incident query 206, a resolution recommendation 710, which may be the same or similar to the resolution recommendation 210, and a reply 716, which may be the same or similar to the reply 216. The incident query thread 774 may associate each of these subcomponents together so that the automated resolution engine 208 can leverage or integrate the incident query thread 774 as a single unit of information for subsequent incident queries and processes.

Returning now to FIG. 2, for incident query threads 774 having a high acceptance rate, the knowledge base updater 260 may review and/or update the knowledge base 238 to incorporate the incident query thread 774 into the historical incident query 242 (425). As can be appreciated, it is advantageous to incorporate incident query threads 774 that have high acceptance rates into the knowledge base 238 because users indicate that the included resolution recommendation 210 resolves the respective issue. Additionally, in addition to updating the knowledge base 238, the incident query thread 774 may also be cached in the incident knowledge checker 224 as part of the past resolutions 226 to aid in efficiently responding to similar incident queries. As subsequent incident query threads 774 involving similar issues are generated, the knowledge base updater 260 may identify if these acceptance rates begin to tread lower, thereby indicating they are no longer relevant to the current environment. For example, surrounding Black Friday, there may be numerous incident queries 206 regarding delays in shipping or payment issues. These issues, however, may be relevant to Black Friday. Thus, as time progresses, subsequent incident queries involving shipping delays or payment issues may no longer be with respect to Black Friday. As such, the acceptance rates for these subsequent incident query threads 774 may begin to indicate that they are not addressing the underlying issue. As such, the automated resolution engine 208 may clear its cache of past resolutions 226 and identify one or more resolution steps based on the current environment, as described above.

In some cases, along with updating the knowledge base 238, the automated resolution engine may also publish a knowledge article 268 based on the resolution recommendation 210 (430). In particular, the automated resolution engine 208 may include a publisher 266 that publishes the knowledge article 268 on a public-facing application or platform, such as a FAQ section provided by a website associated with the service provider 204. In some embodiments, prior to publishing the knowledge article 268, the publisher 266 may provide the incident query thread 774 to a client device 218, which may be the same or similar to the client device 118, for approval. As will be described in greater detail below, the sentiment detector 256 may also provide the sentiment 258 to an acceptance rater 264 for evaluation of the incident query thread 774.

Referring now to FIG. 8, an example knowledge article 868 is illustrated, according to an embodiment herein. As shown, the example knowledge article 868 is a FAQ provided on a web application providing resolution steps 812 for resolving the issue 876 identified in the incident query 506. As can be appreciated, by providing the resolution steps 812 as part of the FAQ section on the service provider’s 204 website, users are provided with the information to efficiently and swiftly resolve the issue 876.

Returning now to FIG. 2, in some embodiments, the sentiment detector 256 determines a negative sentiment present in the reply 216 (435). As noted above, a negative sentiment is interpreted by the automated resolution engine 208 as a lack of acceptance of the resolution recommendation 210 by the user and assumed to not resolve the underlying issue. As such, the automated resolution engine 208 assigns an acceptance rate to the incident query thread 774 indicating a lack of customer satisfaction (440). In particular, the acceptance rater 264 receives the sentiment 258 from the sentiment detector 256 and assigns the acceptance rate to the incident query thread, which reflects the lack of customer satisfaction.

As noted above, the knowledge base updater 260 includes the resolution invalidator 262. The resolution invalidator 262 may continuously analyze incident query threads 774 upon completion of a respective incident and identify incident query threads 774 having low acceptance rates. For incident query threads 774 having low acceptance rates, the resolution invalidator 262 may deprioritize knowledge artifacts used in the generation of a respective resolution recommendation (445). For example, the resolution invalidator 262 may provide feedback to the knowledge artifact identifier 228 and/or the knowledge base 238 indicating that the artifact fingerprints 223 used to generate the resolution recommendation 210 did not provide a satisfactory resolution of the issue. As can be appreciated, the knowledge artifact identifier 228 and/or the knowledge base 238 may use this feedback to inform subsequent identification of knowledge artifacts for incident queries have the same or similar root causes.

In some embodiments, the resolution invalidator 262 may discard at least a subset of the knowledge artifacts used for generation of resolution recommendation 210 based on the acceptance rate of the incident query thread 774 (450). For example, if the previous incident query thread 774 having the same or similar root cause have also had low acceptance rates, then the resolution invalidator 262 may determine that the knowledge artifacts used for the resolution recommendation 210 are no longer accurate and thus purge these knowledge artifacts form the knowledge base 238.

Prior to updating the knowledge base 238, either by adding the incident query thread 774 or by discarding knowledge articles, the automated resolution engine 208 may provide the sentiment 258 for the incident query thread 774 to the client device 218. In some cases, along with the sentiment 258, the automated resolution engine 208 may include the incident query thread 774 and a recommendation to either update the knowledge base 238 or discard the knowledge articles. If the recommendation is to discard knowledge articles, the automated resolution engine 208 may include additional contextual information, such as a graph showing the decline in acceptance rate for incident query threads having the same or similar root cause. In this way, a user of the client device 218 can make an informed decision as to whether to update the knowledge base 238 either by adding the incident query thread 774 or by discarding the knowledge artifacts. If the user agrees with the recommendation, the client device 218 may indicate that the automated resolution engine 208 can proceed with the recommended update.

Referring now to FIG. 9, is a diagram of a system 900 configured to implement an automated resolution engine, according to an embodiment herein. The system 900 may be an example of an apparatus including a computing apparatus 991 that is representative of any system or collection of systems in which the various processes, systems, programs, services, and scenarios disclosed herein may be implemented. For example, computing apparatus 991 may be an example automated resolution engine, such as the automated resolution engine 108 or 208, a client device, such as the client device 102, 118, 202, or 218, or any of the subcomponents depicted in the operational environment 100, the operational environment 200, or the method or flows 300 or 400, respectively. Examples of computing apparatus 991 include, but are not limited to, server computers, desktop computers, laptop computers, routers, switches, web servers, cloud computing platforms, and data center equipment, as well as any other type of physical or virtual server machine, physical or virtual router, container, and any variation or combination thereof.

Computing apparatus 991 may be implemented as a single apparatus, system, or device or may be implemented in a distributed manner as multiple apparatuses, systems, or devices. Computing apparatus 991 may include, but is not limited to, processing system 996, storage system 993, software 995, communication interface system 997, and user interface system 999. Processing system 996 may be operatively coupled with storage system 993, communication interface system 997, and user interface system 999.

Processing system 996 may load and execute software 995 from storage system 993. Software 995 may include an automated resolution engine 992, which may be representative of any of the operations for providing an automated resolution engine or any of its related functions, as discussed with respect to the preceding figures. When executed by processing system 996, software 995 may direct processing system 996 to operate as described herein for at least the various processes, such as the processes 300 or 400, operational scenarios, and sequences discussed in the foregoing implementations. Computing apparatus 991 may optionally include additional devices, features, or functionality not discussed for purposes of brevity.

In some embodiments, processing system 996 may comprise a micro-processor and other circuitry that retrieves and executes software 995 from storage system 993. Processing system 996 may be implemented within a single processing device but may also be distributed across multiple processing devices or sub-systems that cooperate in executing program instructions. Examples of processing system 996 may include general purpose central processing units, graphical processing units, application specific processors, and logic devices, as well as any other type of processing device, combinations, or variations thereof.

Storage system 993 may comprise any memory device or computer-readable storage medium readable by processing system 996 and capable of storing software 995. Storage system 993 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer-readable storage medium a propagated signal.

In addition to computer-readable storage medium, in some implementations storage system 993 may also include computer readable communication media over which at least some of software 995 may be communicated internally or externally. Storage system 993 may be implemented as a single storage device but may also be implemented across multiple storage devices or sub-systems co-located or distributed relative to each other. Storage system 993 may comprise additional elements, such as a controller, capable of communicating with processing system 996 or possibly other systems.

Software 995 (including the automated resolution engine 992 among other functions) may be implemented in program instructions that may, when executed by processing system 996, direct processing system 996 to operate as described with respect to the various operational scenarios, sequences, and processes illustrated herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 995 may include additional processes, programs, or components, such as operating system software, virtualization software, or other application software. Software 995 may also comprise firmware or some other form of machine-readable processing instructions executable by processing system 996.

In general, software 995 may, when loaded into processing system 996 and executed, transform a suitable apparatus, system, or device (of which computing apparatus 991 is representative) overall from a general-purpose computing system into a special-purpose computing system as described herein. Indeed, encoding software 995 on storage system 993 may transform the physical structure of storage system 993. The specific transformation of the physical structure may depend on various factors in different implementations of this description. Examples of such factors may include, but are not limited to, the technology used to implement the storage media of storage system 993 and whether the computer-storage media are characterized as primary or secondary storage, as well as other factors.

For example, if the computer-readable storage medium is implemented as semiconductor-based memory, software 995 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 997 may include communication connections and devices that allow for communication with other computing systems (not shown) over communication networks (not shown). Examples of connections and devices that together allow for inter-system communication may include network interface cards, antennas, power amplifiers, radio-frequency (RF) circuitry, transceivers, and other communication circuitry. The connections and devices may communicate over communication media to exchange communications with other computing systems or networks of systems, such as metal, glass, air, or any other suitable communication media.

Communication between the computing apparatus 991 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random-access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as programmable logic controllers (PLCs), programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, which may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more memory devices or computer readable medium(s) having computer readable program code embodied thereon.

The foregoing examples and descriptions are described herein in the context of systems and methods for providing an automated resolution engine or one or more of its related functions. Those of ordinary skill in the art will realize that these descriptions are illustrative only and are not intended to be in any way limiting. Reference is made in detail to implementations of examples as illustrated in the accompanying drawings. The same reference indicators are used throughout the drawings and the description to refer to the same or like items.

In the interest of clarity, not all of the routine features of the examples described herein are shown and described. It will, of course, be appreciated that in the development of any such actual implementation, numerous implementation-specific decisions must be made in order to achieve the developer’s specific goals, such as compliance with application- and business-related constraints, and that these specific goals will vary from one implementation to another and from one developer to another. That is, the foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in an embodiment,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

Unless the context clearly requires otherwise, throughout the description and the claims, the words "comprise," "comprising," and the like are to be construed in an inclusive sense, as opposed to an exclusive or exhaustive sense; that is to say, in the sense of "including, but not limited to." As used herein, the terms "connected," "coupled," or any variant thereof means any connection or coupling, either direct or indirect, between two or more elements; the coupling or connection between the elements can be physical, logical, or a combination thereof. Additionally, the words "herein," "above," "below," and words of similar import, when used in this application, refer to this application as a whole and not to any particular portions of this application. Where the context permits, words in the above Detailed Description using the singular or plural number may also include the plural or singular number respectively. The word "or," in reference to a list of two or more items, covers all the following interpretations of the word: any of the items in the list, all the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub combinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words "means for” but use of the term "for" in any other context is not intended to invoke treatment under 35 U.S.C. § 112(f). Accordingly, the applicant reserves the right to pursue additional claims after filing this application to pursue such additional claim forms, in either this application or in a continuing application.

### EXAMPLES

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4”).

Example 1 is a computing apparatus comprising: a computer-readable storage medium; processor-executable instructions stored on the computer-readable storage medium; and one or more processors coupled to the computer-readable storage medium and configured to execute the processor-executable instructions to operate an automated resolution engine, such that the processor-executable instructions, when executed by the one or more processors, direct the computing apparatus, to at least: determine an incident query received from a client device; generate an incident fingerprint based on the incident query; generate a plurality of knowledge artifacts based on the incident fingerprint; generate a resolution recommendation for the incident query based on the incident fingerprint and the plurality of knowledge artifacts; and transmit the resolution recommendation to the client device.

Example 2 is the computing apparatus of any previous or subsequent Example, wherein the processor-executable instructions to generate the plurality of knowledge artifacts based on the incident fingerprint, when executed by the one or more processors, further direct the computing apparatus to: query a knowledge base comprising a plurality of historical incident threads and a plurality of knowledge articles; responsive to the query, retrieve a subset of historical incident threads and a subset of knowledge articles identified as contextually relevant to the incident fingerprint; apply a cosine similarity reranking process to the subset of knowledge articles and the subset of historical incident threads; and identify the plurality of knowledge artifacts based on the cosine similarity reranking process.

Example 3 is the computing apparatus of any previous or subsequent Example, wherein the processor-executable instructions to generate the resolution recommendation for the incident query based on the incident fingerprint and the plurality of knowledge artifacts, when executed by the one or more processors, further direct the computing apparatus to: generate a prompt comprising a request for resolution steps to the incident query; chain the prompt with a plurality of artifact fingerprints associated with the plurality of knowledge artifacts, wherein an artifact fingerprint corresponds with a respective knowledge artifact; and submit the chained prompt to an artificial intelligence (AI) model, wherein: responsive to the chained prompt, the AI model generates a plurality of resolution steps for the incident query; and the resolution recommendation comprises the plurality of resolution steps.

Example 4 is the computing apparatus of any previous or subsequent Example, wherein the processor-executable instructions to generate the resolution recommendation for the incident query based on the incident fingerprint and the plurality of knowledge artifacts, when executed by the one or more processors, further direct the computing apparatus to: submit the incident fingerprint and the plurality of knowledge artifacts to an AI model; receive an output from the AI model, wherein the output comprises a plurality of resolution steps; validate the plurality of resolution steps against the incident fingerprint; and generate the resolution recommendation comprising the plurality of resolution steps.

Example 5 is the computing apparatus of any previous or subsequent Example, wherein the processor-executable instructions, when executed by the one or more processors, further direct the computing apparatus to: receive, from the client device, a reply associated with the incident query; determine positive sentiment present in the reply associated with an incident query; and publish on a public-facing application the resolution recommendation responsive to the positive sentiment.

Example 6 is the computing apparatus of any previous or subsequent Example, wherein the processor-executable instructions, when executed by the one or more processors, further direct the computing apparatus to: determine that the resolution recommendation is invalid; deprioritize the plurality of knowledge artifacts based on the resolution recommendation being invalid; and initiate removal of a plurality of knowledge articles and a plurality of incident query threads associated with the plurality of knowledge artifacts from a knowledge base.

Example 7 is a method comprising: receiving, by an automated resolution engine, an incident query from a client device; generating, by the automated resolution engine, an incident fingerprint based on the incident query; determining, by the automated resolution engine, a plurality of artifact fingerprints based on the incident fingerprint, wherein the plurality of artifact fingerprints is contextually relevant to the incident fingerprint; generating, by the automated resolution engine, a plurality of resolution steps based on the plurality of artifact fingerprints and the incident fingerprint; validating, by the automated resolution engine, the plurality of resolution steps based on the incident fingerprint; and generating, by the automated resolution engine, a resolution recommendation for the incident query, wherein the resolution recommendation comprises the plurality of resolution steps.

Example 8 is the method of any previous or subsequent Example, wherein determining, by the automated resolution engine, the plurality of artifact fingerprints comprises: querying, by the automated resolution engine, a knowledge base for a plurality of knowledge artifacts that are contextually relevant to the incident fingerprint, wherein the plurality of knowledge artifacts comprises: a plurality of historical incident threads and a plurality of knowledge articles; and identifying, by the automated resolution engine, the plurality of artifact fingerprints from the plurality of knowledge artifacts, wherein the plurality of artifact fingerprints is identified based on a cosine distance between the artifact fingerprints to the incident fingerprint, wherein the cosine distance indicates a contextual relevance of a respective knowledge artifact to the incident query.

Example 9 is the method of any previous or subsequent Example, wherein the method further comprises: generating, by the automated resolution engine, a knowledge base comprising a plurality of knowledge artifacts, wherein generating the knowledge base comprises: ingesting, by the automated resolution engine, a plurality of historical incident threads into the knowledge base; and ingesting, by the automated resolution engine, a plurality of knowledge articles into the knowledge base, wherein ingesting into the knowledge base comprises generating, by the automated resolution engine, embeddings of each respective historical incident thread or knowledge article.

Example 10 is the method of any previous or subsequent Example, wherein generating, by the automated resolution engine, the plurality of resolutions steps based on the plurality of artifact fingerprints and the incident fingerprint comprises: generating, by the automated resolution engine, a chained prompt comprising a request for resolution steps to the incident query chained to the plurality of artifact fingerprints; and submitting, by the automated resolution engine, the chained prompt to an artificial intelligence (AI) model, wherein responsive to the chained prompt, the AI model generates the plurality of resolution steps for the incident query.

Example 11 is the method of any previous or subsequent Example, wherein determining, by the automated resolution engine, the plurality of artifact fingerprints based on the incident fingerprint comprises: querying, by the automated resolution engine, a knowledge base comprising a plurality of historical incident threads and a plurality of knowledge articles; responsive to the query, retrieving, by the automated resolution engine, a subset of historical incident threads and a subset of knowledge articles identified as contextually relevant to the incident fingerprint; ranking, by the automated resolution engine, the subset of knowledge articles and the subset of historical incident threads based on a contextual relevance of each to the incident fingerprint; and identifying, by the automated resolution engine, the plurality of artifact fingerprints based on the ranking process.

Example 12 is the method of any previous or subsequent Example, wherein the method further comprises: transmitting, by the automated resolution engine, the resolution recommendation for the incident query to the client device; receiving, by the automated resolution engine, a second incident query from a second client device; generating, by the automated resolution engine, a second incident fingerprint from the second incident query; determining, by the automated resolution engine, that the second incident query comprises a similar root cause to the incident query based on the second incident fingerprint and the incident fingerprint; and generating, by the automated resolution engine, a second resolution recommendation comprising the resolution steps based on the second incident query comprising the similar root cause to the incident query.

Example 13 is the method of any previous or subsequent Example, wherein the method further comprises: receiving, by the automated resolution engine, a reply from the client device responsive to the resolution recommendation; determining, by the automated resolution engine, a negative sentiment present in the reply; and deprioritizing, by the automated resolution engine, a plurality of knowledge artifacts associated with the plurality of artifact fingerprints based on the negative sentiment.

Example 14 is a computer-readable storage medium comprising processor-executable instructions, wherein the processor-executable instructions, in part, operate an automated resolution engine such to cause one or more processors to: generate, by an automated resolution engine, an incident fingerprint of an incident query received from a client device; query, by the automated resolution engine, a knowledge base using the incident fingerprint; identify, by the automated resolution engine, a plurality of knowledge artifacts that are contextually relevant to the incident query; determine, by the automated resolution engine, a plurality of artifact fingerprints associated with a subset of the plurality of knowledge artifacts; generate, by the automated resolution engine, a resolution recommendation for the incident query based on the plurality of artifact fingerprints and the incident fingerprint; receive, by the automated resolution engine, a reply from the client device responsive to the resolution recommendation; determine, by the automated resolution engine, a sentiment of the reply; and update, by the automated resolution engine, the knowledge base based on the sentiment of the reply.

Example 15 is the computer-readable storage medium of any previous or subsequent Example, wherein the processor-executable instructions to generate, by the automated resolution engine, the incident fingerprint of the incident query received from the client device cause the one or more processors to further execute processor-executable instructions stored in the computer-readable storage medium to: preprocess, by the automated resolution engine, the incident query to form a preprocessed incident query; and generate, by the automated resolution engine, an embedding representation based on the preprocessed incident query, wherein the incident fingerprint comprises the embedding representation.

Example 16 is the computer-readable storage medium of any previous or subsequent Example, wherein the processor-executable instructions to generate, by the automated resolution engine, the resolution recommendation for the incident query based on the plurality of artifact fingerprints and the incident fingerprint cause the one or more processors to further execute processor-executable instructions stored in the computer-readable storage medium to: generate, by the automated resolution engine, an input comprising the plurality of artifact fingerprints and the incident fingerprint; perform, by the automated resolution engine, a Retrieval-Automated Generation (RAG) process using the input; and generate, by the automated resolution engine, the resolution recommendation comprising a plurality of resolution steps generated during the RAG process.

Example 17 is the computer-readable storage medium of any previous or subsequent Example, wherein: the processor-executable instructions to determine, by the automated resolution engine, the sentiment of the reply cause the one or more processors to further execute processor-executable instructions stored in the computer-readable storage medium to: detect, by the automated resolution engine, a positive sentiment present in the resolution recommendation; and the processor-executable instructions to update, by the automated resolution engine, the knowledge base based on the sentiment of the reply cause the one or more processors to further execute processor-executable instructions stored in the computer-readable storage medium to: ingest, by the automated resolution engine, an incident query thread associated with the incident query into the knowledge base responsive to detecting the positive sentiment.

Example 18 is the computer-readable storage medium of any previous or subsequent Example, wherein: the processor-executable instructions to determine, by the automated resolution engine, the sentiment of the reply cause the one or more processors to further execute processor-executable instructions stored in the computer-readable storage medium to: detect, by the automated resolution engine, a negative sentiment present in the resolution recommendation; and the processor-executable instructions to update, by the automated resolution engine, the knowledge base based on the sentiment of the reply cause the one or more processors to further execute processor-executable instructions stored in the computer-readable storage medium to: delete, by the automated resolution engine, at least a subset of the plurality of knowledge artifacts from the knowledge base responsive to detecting the negative sentiment.

Example 19 is the computer-readable storage medium of any previous or subsequent Example, wherein the processor-executable instructions to generate, by the automated resolution engine, the resolution recommendation for the incident query cause the one or more processors to further execute processor-executable instructions stored in the computer-readable storage medium to: generate, by the automated resolution engine, a chained prompt comprising a template request for resolution steps to the incident query, wherein the chained prompt chains the template request to plurality of artifact fingerprints; submit, by the automated resolution engine, the chained prompt to an artificial intelligence (AI) model, wherein responsive to the chained prompt, the AI model generates a plurality of resolution steps for the incident; validate, by the automated resolution engine, the plurality of resolution steps for the incident; and generate, by the automated resolution engine, the resolution recommendation for the incident query comprising the resolution steps based on the validation of the plurality of resolution steps.

Example 20 is the computer-readable storage medium of any previous or subsequent Example, wherein the processor-executable instructions cause the one or more processors to further execute processor-executable instructions stored in the computer-readable storage medium to: receive, by the automated resolution engine, a second incident query from a second client device; generate, by the automated resolution engine, a second incident fingerprint from the second incident query; determine, by the automated resolution engine, that the second incident query comprises a similar root cause to the incident query based on the second incident fingerprint and the incident fingerprint; and generate, by the automated resolution engine, a second resolution recommendation comprising the resolution recommendation based on the second incident query having the similar root cause to the incident query and the sentiment of the reply being positive.

What is claimed is:

1. A computing apparatus comprising:
a computer-readable storage medium;
processor-executable instructions stored on the computer-readable storage medium; and
one or more processors coupled to the computer-readable storage medium and configured to execute the processor-executable instructions to operate an automated resolution engine, such that the processor-executable instructions, when executed by the one or more processors, direct the computing apparatus, to at least:determine an incident query received from a client device;generate an incident fingerprint based on the incident query;generate a plurality of knowledge artifacts based on the incident fingerprint;generate a resolution recommendation for the incident query based on the incident fingerprint and the plurality of knowledge artifacts; andtransmit the resolution recommendation to the client device.

2. The computing apparatus of claim 1, wherein the processor-executable instructions to generate the plurality of knowledge artifacts based on the incident fingerprint, when executed by the one or more processors, further direct the computing apparatus to:
query a knowledge base comprising a plurality of historical incident threads and a plurality of knowledge articles;
responsive to the query, retrieve a subset of historical incident threads and a subset of knowledge articles identified as contextually relevant to the incident fingerprint;
apply a cosine similarity reranking process to the subset of knowledge articles and the subset of historical incident threads; and
identify the plurality of knowledge artifacts based on the cosine similarity reranking process.

3. The computing apparatus of claim 1, wherein the processor-executable instructions to generate the resolution recommendation for the incident query based on the incident fingerprint and the plurality of knowledge artifacts, when executed by the one or more processors, further direct the computing apparatus to:
generate a prompt comprising a request for resolution steps to the incident query;
chain the prompt with a plurality of artifact fingerprints associated with the plurality of knowledge artifacts, wherein an artifact fingerprint corresponds with a respective knowledge artifact; and
submit the chained prompt to an artificial intelligence (Al) model, wherein:responsive to the chained prompt, the Al model generates a plurality of resolution steps for the incident query; andthe resolution recommendation comprises the plurality of resolution steps.

4. The computing apparatus of claim 1, wherein the processor-executable instructions to generate the resolution recommendation for the incident query based on the incident fingerprint and the plurality of knowledge artifacts, when executed by the one or more processors, further direct the computing apparatus to:
submit the incident fingerprint and the plurality of knowledge artifacts to an Al model;
receive an output from the Al model, wherein the output comprises a plurality of resolution steps;
validate the plurality of resolution steps against the incident fingerprint; and
generate the resolution recommendation comprising the plurality of resolution steps.

5. The computing apparatus of claim 1, wherein the processor-executable instructions, when executed by the one or more processors, further direct the computing apparatus to:
receive, from the client device, a reply associated with the incident query;
determine positive sentiment present in the reply associated with an incident query; and
publish on a public-facing application the resolution recommendation responsive to the positive sentiment.Page |3

6. The computing apparatus of claim 1, wherein the processor-executable instructions, when executed by the one or more processors, further direct the computing apparatus to:
determine that the resolution recommendation is invalid;
deprioritize the plurality of knowledge artifacts based on the resolution recommendation being invalid; and
initiate removal of a plurality of knowledge articles and a plurality of incident query threads associated with the plurality of knowledge artifacts from a knowledge base.

7. A method comprising:
receiving, by an automated resolution engine, an incident query from a client device;
generating, by the automated resolution engine, an incident fingerprint based on the incident query;
determining, by the automated resolution engine, a plurality of artifact fingerprints based on the incident fingerprint, wherein the plurality of artifact fingerprints is contextually relevant to the incident fingerprint;
generating, by the automated resolution engine, a plurality of resolution steps based on the plurality of artifact fingerprints and the incident fingerprint;
validating, by the automated resolution engine, the plurality of resolution steps based on the incident fingerprint; and
generating, by the automated resolution engine, a resolution recommendation for the incident query, wherein the resolution recommendation comprises the plurality of resolution steps.

8. The method of claim 7, wherein determining, by the automated resolution engine, the plurality of artifact fingerprints comprises:
querying, by the automated resolution engine, a knowledge base for a plurality of knowledge artifacts that are contextually relevant to the incident fingerprint, wherein the plurality of knowledge artifacts comprises: a plurality of historical incident threads and a plurality of knowledge articles; and
identifying, by the automated resolution engine, the plurality of artifact fingerprints from the plurality of knowledge artifacts, wherein the plurality of artifact fingerprints is identified based
on a cosine distance between the artifact fingerprints to the incident fingerprint, wherein the cosine distance indicates a contextual relevance of a respective knowledge artifact to the incident query.

9. The method of claim 7, wherein the method further comprises:
generating, by the automated resolution engine, a knowledge base comprising a plurality of knowledge artifacts, wherein generating the knowledge base comprises:ingesting, by the automated resolution engine, a plurality of historical incident threads into the knowledge base; andingesting, by the automated resolution engine, a plurality of knowledge articles into the knowledge base,wherein ingesting into the knowledge base comprises generating, by the automated resolution engine, embeddings of each respective historical incident thread or knowledge article.

10. The method of claim 7, wherein generating, by the automated resolution engine, the plurality of resolutions steps based on the plurality of artifact fingerprints and the incident fingerprint comprises:
generating, by the automated resolution engine, a chained prompt comprising a request for resolution steps to the incident query chained to the plurality of artifact fingerprints; and
submitting, by the automated resolution engine, the chained prompt to an artificial intelligence (Al) model, wherein responsive to the chained prompt, the Al model generates the plurality of resolution steps for the incident query.

11. The method of claim 7, wherein determining, by the automated resolution engine, the plurality of artifact fingerprints based on the incident fingerprint comprises:
querying, by the automated resolution engine, a knowledge base comprising a plurality of historical incident threads and a plurality of knowledge articles;
responsive to the query, retrieving, by the automated resolution engine, a subset of historical incident threads and a subset of knowledge articles identified as contextually relevant to the incident fingerprint;Page |5
ranking, by the automated resolution engine, the subset of knowledge articles and the subset of historical incident threads based on a contextual relevance of each to the incident fingerprint; andidentifying, by the automated resolution engine, the plurality of artifact fingerprints based on the ranking process.

12. The method of claim 7, wherein the method further comprises:
transmitting, by the automated resolution engine, the resolution recommendation for the incident query to the client device;
receiving, by the automated resolution engine, a second incident query from a second client device;
generating, by the automated resolution engine, a second incident fingerprint from the second incident query;
determining, by the automated resolution engine, that the second incident query comprises a similar root cause to the incident query based on the second incident fingerprint and the incident fingerprint; and
generating, by the automated resolution engine, a second resolution recommendation comprising the resolution steps based on the second incident query comprising the similar root cause to the incident query.

13. The method of claim 7, wherein the method further comprises:
receiving, by the automated resolution engine, a reply from the client device responsive to the resolution recommendation;
determining, by the automated resolution engine, a negative sentiment present in the reply;
and deprioritizing, by the automated resolution engine, a plurality of knowledge artifacts associated with the plurality of artifact fingerprints based on the negative sentiment.

14. A computer-readable storage medium comprising processor-executable instructions, wherein the processor-executable instructions, in part, operate an automated resolution engine such to cause one or more processors to:
generate, by an automated resolution engine, an incident fingerprint of an incident query received from a client device;query, by the automated resolution engine, a knowledge base using the incident fingerprint;identify, by the automated resolution engine, a plurality of knowledge artifacts that are contextually relevant to the incident query;determine, by the automated resolution engine, a plurality of artifact fingerprints associated with a subset of the plurality of knowledge artifacts;generate, by the automated resolution engine, a resolution recommendation for the incident query based on the plurality of artifact fingerprints and the incident fingerprint;receive, by the automated resolution engine, a reply from the client device responsive to the resolution recommendation;determine, by the automated resolution engine, a sentiment of the reply; andupdate, by the automated resolution engine, the knowledge base based on the sentiment of the reply.

15. The computer-readable storage medium of claim 14, wherein the processor-executable instructions to generate, by the automated resolution engine, the incident fingerprint of the incident query received from the client device cause the one or more processors to further execute processor-executable instructions stored in the computer-readable storage medium to:
preprocess, by the automated resolution engine, the incident query to form a preprocessed incident query; and
generate, by the automated resolution engine, an embedding representation based on the preprocessed incident query, wherein the incident fingerprint comprises the embedding representation.

16. The computer-readable storage medium of claim 14, wherein the processor-executable instructions to generate, by the automated resolution engine, the resolution recommendation for the incident query based on the plurality of artifact fingerprints and the incident fingerprint cause the one or more processors to further execute processor-executable instructions stored in the computer-readable storage medium to:Page |7
generate, by the automated resolution engine, an input comprising the plurality of artifact fingerprints and the incident fingerprint;perform, by the automated resolution engine, a Retrieval-Automated Generation (RAG) process using the input; andgenerate, by the automated resolution engine, the resolution recommendation comprising a plurality of resolution steps generated during the RAG process.

17. The computer-readable storage medium of claim 14, wherein:
the processor-executable instructions to determine, by the automated resolution engine, the sentiment of the reply cause the one or more processors to further execute processor-executable instructions stored in the computer-readable storage medium to:detect, by the automated resolution engine, a positive sentiment present in the resolution recommendation; and
the processor-executable instructions to update, by the automated resolution engine, the knowledge base based on the sentiment of the reply cause the one or more processors to further execute processor-executable instructions stored in the computer-readable storage medium to:ingest, by the automated resolution engine, an incident query thread associated with the incident query into the knowledge base responsive to detecting the positive sentiment.

18. The computer-readable storage medium of claim 14, wherein:
the processor-executable instructions to determine, by the automated resolution engine, the sentiment of the reply cause the one or more processors to further execute processor-executable instructions stored in the computer-readable storage medium to:detect, by the automated resolution engine, a negative sentiment present in the resolution recommendation; and
the processor-executable instructions to update, by the automated resolution engine, the knowledge base based on the sentiment of the reply cause the one or more processors to further execute processor-executable instructions stored in the computer-readable storage medium to:delete, by the automated resolution engine, at least a subset of the plurality of knowledge artifacts from the knowledge base responsive to detecting the negative sentiment.

19. The computer-readable storage medium of claim 14, wherein the processor-executable instructions to generate, by the automated resolution engine, the resolution recommendation for the incident query cause the one or more processors to further execute processor-executable instructions stored in the computer-readable storage medium to:
generate, by the automated resolution engine, a chained prompt comprising a template request for resolution steps to the incident query, wherein the chained prompt chains the template request to plurality of artifact fingerprints;
submit, by the automated resolution engine, the chained prompt to an artificial intelligence (AI) model, wherein responsive to the chained prompt, the AI model generates a plurality of resolution steps for the incident;
validate, by the automated resolution engine, the plurality of resolution steps for the incident; and
generate, by the automated resolution engine, the resolution recommendation for the incident query comprising the resolution steps based on the validation of the plurality of resolution steps.

20. The computer-readable storage medium of claim 14, wherein the processor-executable instructions cause the one or more processors to further execute processor- executable instructions stored in the computer-readable storage medium to:
receive, by the automated resolution engine, a second incident query from a second client device;
generate, by the automated resolution engine, a second incident fingerprint from the second incident query;
determine, by the automated resolution engine, that the second incident query comprises a similar root cause to the incident query based on the second incident fingerprint and the incident fingerprint; and
generate, by the automated resolution engine, a second resolution recommendation comprising the resolution recommendation based on the second incident query having the similar root cause to the incident query and the sentiment of the reply being positive.Page |9
